(19) United States
(12) Patent Application Publication
(10) Pub. No.: US 2006/0221447 A1
(43) Pub. Date: Oct. 5, 2006

(54) Stabilized polarizing beam splitter assembly

(75) Inventors: James P. DiZio, St. Paul, MN (US); Maureen C. Nelson, West St. Paul, MN (US); Robert S. Clough, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/096,062

(22) Filed: Mar. 31, 2005

(51) Int. Cl. G02B 5/30

(52) U.S. Cl. 359/491; 359/501

(57) ABSTRACT

A polarizing beam splitter includes a polyester polarizing film, an adhesive layer disposed on the polyester polarizing film, a first rigid cover disposed on the adhesive layer, and a second rigid cover disposed adjacent to the polyester polarizing film. The adhesive layer includes an adhesive and a hindered amine, benzophenone, or triazine.

### TECHNICAL FIELD

The present disclosure is directed generally to polarizing beam splitters and the use of such devices in, for example, systems for displaying information, and more particularly to projection systems.

### BACKGROUND

Optical imaging systems typically include a transmissive or a reflective liquid crystal display (LCD) imager, also referred to as a light valve or light valve array, which imposes an image on a light beam. Transmissive light valves are typically translucent and allow light to pass through. Reflective light valves reflect the input beam to form an image.

Many LCD imagers rotate the polarization of incident light. In other words, polarized light is either reflected (or transmitted) by the imager with its polarization state substantially unmodified for the darkest state or with a degree of polarization rotation imparted to provide a desired grey scale. A 90° rotation provides the brightest state in these systems. Accordingly, a polarized light beam is generally used as the input beam for LCD imagers. A desirable compact arrangement includes a folded light path between a polarizing beam splitter (PBS) and a reflective imager, wherein the illuminating beam and the projected image reflected from the imager share the same physical space between the PBS and the imager. The PBS separates the incoming light from the polarization-rotated image light. A conventional PBS used in a projector system, sometimes referred to as a MacNeille polarizer, uses a stack of inorganic dielectric films placed at Brewster's angle. Light having s-polarization is reflected, while light in the p-polarization state is transmitted through the polarizer.

### SUMMARY

Generally, the present disclosure relates to an apparatus for improving performance of a projection system. In particular, the disclosure is based around an imaging core that includes improved stability and lifetime of a polarizing beam splitter (PBS).

One embodiment of the present disclosure provides a polarizing beam splitter (PBS) that includes a polyester polarizing film, an adhesive layer disposed on the polyester polarizing film, a first rigid cover disposed on the adhesive layer, and a second rigid cover disposed adjacent to the polyester polarizing film. The adhesive layer includes an adhesive and a hindered amine, benzophenone, or triazine type stabilizer. In some embodiments, the polarizing film is a multilayer reflective polarizing film. In some embodiments, the polarizing film is a matched z-index multilayer reflective polarizing film.

In another embodiment, a projection system is disclosed. The projection system includes a light source to generate light, an imaging core to impose an image on generated light from the light source to form image light, an ultraviolet light filter disposed between the light source and at least a portion of the imaging core, and a projection lens system to project the image light from the imaging core. The imaging core includes at least one polarizing beam splitter and at least one imager. The polarizing beam splitter includes a polyester polarizing film, an adhesive layer disposed on the polyester polarizing film and between the light source and the polyester polarizing film, a first rigid cover disposed on the adhesive layer, and a second rigid cover disposed adjacent to the polyester polarizing film. The adhesive layer includes an adhesive and a hindered amine, benzophenone, or triazine type stabilizer.

In a further embodiment, a method of stabilizing a polyester film is disclosed. The method includes disposing an adhesive layer on a polyester film, and passing light through the adhesive layer and then through the polyester film, where at least 99% of the light has a wavelength above 400 nanometers. The adhesive layer includes an adhesive, and a U.V. absorber.

### BRIEF DESCRIPTION OF THE DRAWINGS

The disclosure may be more completely understood in consideration of the following detailed description of various embodiments of the disclosure in connection with the accompanying drawings, in which:

FIG. 1 schematically illustrates an embodiment of a projection unit based on a single reflective imager;

FIG. 2 schematically illustrates an embodiment of a PBS having a multilayer reflective polarizing film; and

FIG. 3 schematically illustrates another embodiment of a projection unit based on multiple reflective imagers.

### DETAILED DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Weight percent, percent by weight, % by weight, % wt, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to a composition containing “a light stabilizer” encompass embodiments having one, two or more light stabilizers. As used in this specification and the appended claims, the term “or” is generally employed in its sense including “and/or” unless the content clearly dictates otherwise.

This disclosure is generally related to 3M docket No. 60543US002 entitled “POLARIZING BEAM SPLITTER ASSEMBLY HAVING REDUCED STRESS,” filed on Mar. 31, 2005, and incorporated by reference herein.

The present disclosure is applicable to optical imagers. In particular, the disclosure is based around an imaging core that includes improved stability and lifetime of a polarizing beam splitter (PBS). The disclosed PBS includes an adhesive layer including a light stabilizer that improves the stability and/or lifetime of the PBS.

The PBS of the present disclosure may be used in various optical imager systems. The term “optical imager system” as used herein is meant to include a wide variety of optical systems that produce an image for a viewer to view. Optical imager systems of the present disclosure may be used, for example, in front and rear projection systems, projection displays, head-mounted displays, virtual viewers, heads-up displays, optical computing systems, optical correlation systems, and other optical viewing and display systems.

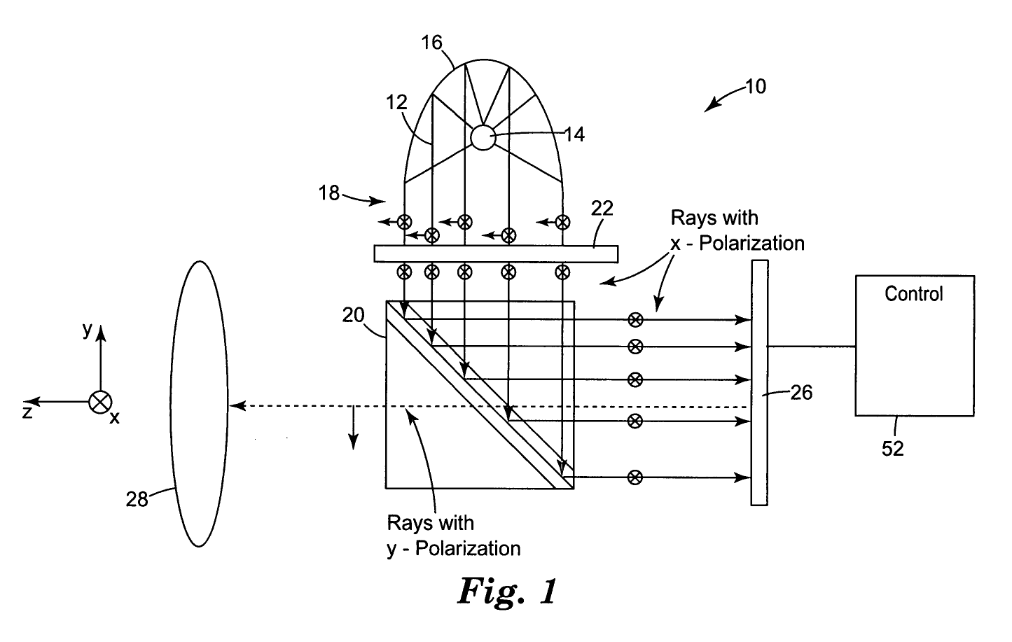

One embodiment of an optical imager system is illustrated in FIG. 1, where system 10 includes a light source 12, for example an arc lamp 14 with a reflector 16 to direct non-polarized light 18 (indicated by the circled x and solid arrow on the light ray) in a forward direction. The light source 12 may also be a solid-state light source, such as light emitting diodes or a laser light source.

The system 10 includes a PBS 20, e.g., a single or multi-film PBS described below. Light with x-polarization, i.e., polarized in a direction parallel to the x-axis, is indicated by the circled x. Light with y-polarization or z-polarization, i.e., polarized in a direction parallel to the y-axis or z-axis, depending on its direction of propagation, is indicated by a solid arrow. Solid lines indicate incident light, while dashed lines indicate light that has been returned from a reflective imager 26 with a changed polarization state. Light provided by the source 12 can be conditioned by conditioning optics 22 before illuminating the PBS 20. The conditioning optics 22 can change the characteristics of the light emitted by the source 12 to characteristics that are desired by the projection system. In one embodiment, the conditioning optics 22 may alter any one or more of the divergence of the light, the polarization state of the light, or the spectrum of the light. The conditioning optics 22 may include, for example, one or more lenses, a polarization converter, a pre-polarizer, and/or a filter to remove unwanted ultraviolet or infrared light.

In illustrative embodiments, the conditioning optics 22 include a light filter or “cut” filter. The light filter 22 allows a specified range of light wavelength to pass to the PBS and blocks a second specified range of light wavelength from the PBS. In some embodiments, the light filter 22 blocks ultraviolet (UV) light from the PBS. In one embodiment, the light filter 22 allows light only above 400 nm or 425 nm to pass to the PBS, such that 99% of the light passing to the PBS has a wavelength above 400 nm or above 425 nm.

The x-polarized components of the light are reflected by the PBS 20 to the reflective imager 26. The liquid crystal mode of reflective imager 26 may be smectic, nematic, or some other suitable type of reflective imager. If the reflective imager 26 is smectic, the reflective imager 26 may be a ferroelectric liquid crystal display (FLCD). The imager 26 reflects and modulates an image beam having y-polarization. The reflected y-polarized light is transmitted through the PBS 20 and is projected by a projection lens system 28, the design of which is typically optimized for each particular optical system, taking into account all the components between the lens system 28 and the imager(s). A controller 52 is coupled to the reflective imager 26 to control the operation of the reflective imager 26. Typically, the controller 52 activates the different pixels of the imager 26 to create an image in the reflected light.

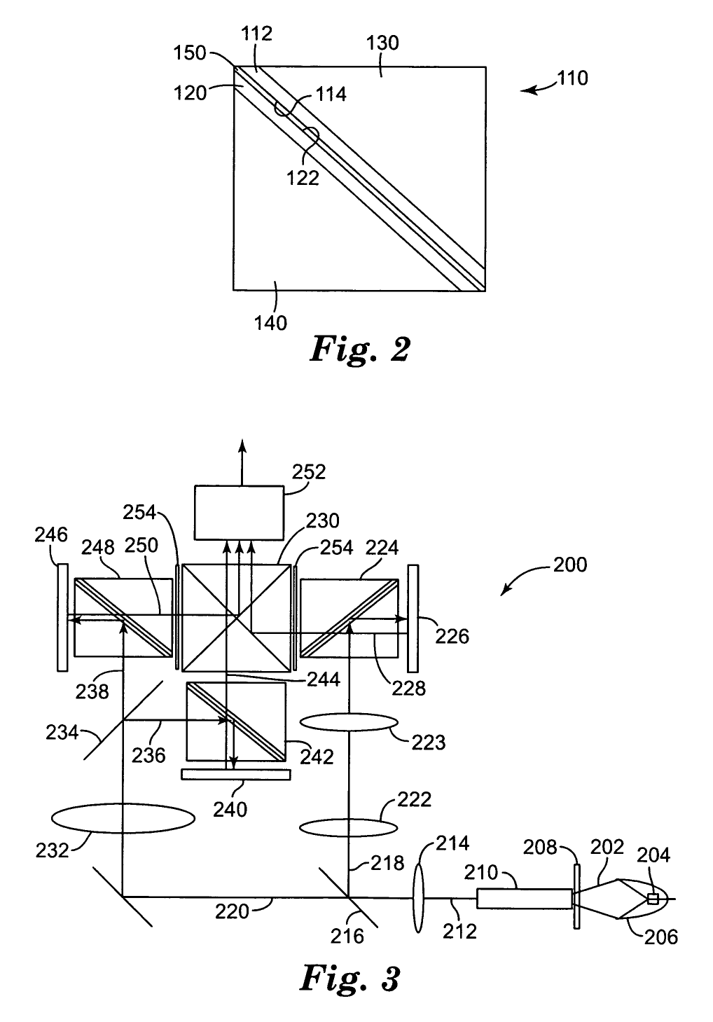

FIG. 2 illustrates one embodiment of a polarizing beam splitter 110 that utilizes an adhesive layer including a light stabilizer disposed on a polyester polarizing film according to the present disclosure. In this embodiment, polarizing beam splitter 110 includes a polyester polarizer film 150 such as, for example, a multilayer reflective polarizing film. The film 150 may be any suitable multilayer reflective polarizing film known in the art. In some embodiments, the film 150 is a multilayer reflective polarizing film including polyethylene terephthalate (PET) and a copolymer of PET (coPET). In some embodiments, the film 150 is a matched z-index polarizer film. The illustrated multilayer film 150 has a first surface 114 and a second opposing surface 122. An adhesive layer 112, 120 is disposed on the multilayer reflective polarizing film 150 first surface 114 and/or second surface 122. A first rigid cover 130 is disposed on the adhesive layer 112. A second rigid cover 140 is adjacent to the multilayer reflective polarizing film 150. A second adhesive layer 120 can be disposed between the second rigid cover 140 and the multilayer reflective polarizing film 150. In some embodiments, the polarizing beam splitter 110 includes two polyester polarizer films. In some embodiments, the polarizing beam splitter 110 includes three or more polyester polarizer films. In some embodiments, an adhesive layer is disposed between the two or more polyester polarizing films.

Although depicted as including two prisms 130 and 140, the PBS 110 may include any suitable cover(s) disposed on one or either side of the multilayer reflective polarizing film 150. The prisms 130 and 140 can be constructed from any light transmissive material having a suitable refractive index to achieve the desired purpose of the PBS. The prisms should have refractive indices less than that which would create a total internal reflection condition, i.e., a condition where the propagation angle approaches or exceeds 90° under normal usage conditions (e.g., where incident light is normal to one face of the prism). Such condition can be calculated using Snell's law. Preferably, the prisms are made of isotropic materials, although other materials can be used. A “light transmissive” material is one that allows at least a portion of incident light from the light source to transmit through the material. In some applications, the incident light can be pre-filtered to eliminate undesirable wavelengths. Suitable materials for use as prisms include, but are not limited to, ceramics, glass, and polymers. One useful category of glass includes a lead-free glass known as SK5 commercially available from Schott, as described in US Patent Publication 2004-0227994.

The PBS assembly 110 can have a high light intensity rigid cover 130 and a lower light intensity rigid cover 140. The high light intensity rigid cover 130 is the rigid cover that is closest to the light source (see FIGS. 1 and 3). The high light intensity rigid cover 130 experiences light at a higher intensity than the lower light intensity rigid cover 140. In many embodiments, it is desirable to place the adhesive layer 112 including the light stabilizers between this high light intensity rigid cover 130 and the polyester multilayer reflective polarizing film 150. The optical and physical properties of the adhesive layer 112 allows the polyester film 150 to remain stable under high intensity light.

The adhesive layer(s) 112, 120 may include a pressure sensitive adhesive or a non-pressure sensitive adhesive (e.g., a thermally cured adhesive or a moisture cure adhesive). In some embodiments, the adhesive is a pressure sensitive adhesive. In some embodiments, the adhesive layer is a clear adhesive. In some embodiments, the adhesive layer contains low amounts of residuals (e.g., a low outgassing adhesive).

One class of materials useful for the adhesive includes acrylate and methacrylate polymers and copolymers. Such polymers are formed, for example, by polymerizing one or more monomeric acrylic or methacrylic esters of non-tertiary alkyl alcohols, with the alkyl groups having from 1 to about 20 carbon atoms (e.g., from 3 to 18 carbon atoms). Suitable acrylate monomers include, for example, methyl acrylate, ethyl acrylate, n-butyl acrylate, lauryl acrylate, 2-ethylhexyl acrylate, cyclohexyl acrylate, iso-octyl acrylate, octadecyl acrylate, nonyl acrylate, decyl acrylate, and dodecyl acrylate. The corresponding methacrylates are useful as well. Also useful are aromatic acrylates and methacrylates, e.g., benzyl acrylate. Optionally, one or more monoethylenically unsaturated co-monomers may be polymerized with the acrylate or methacrylate monomers. The particular type and amount of co-monomer is selected based upon the desired properties of the polymer.

One group of useful co-monomers includes those having a homopolymer glass transition temperature greater than the glass transition temperature of the (meth)acrylate (i.e., acrylate or methacrylate) homopolymer. Examples of suitable co-monomers falling within this group include acrylic acid, acrylamides, methacrylamides, substituted acrylamides (such as N,N-dimethyl acrylamide), itaconic acid, methacrylic acid, acrylonitrile, methacrylonitrile, vinyl acetate, N-vinyl pyrrolidone, isobornyl acrylate, cyano ethyl acrylate, N-vinylcaprolactam, maleic anhydride, hydroxyalkyl(meth)-acrylates, N,N-dimethyl aminoethyl(meth)acrylate, N,N-diethylacrylamide, beta-carboxyethyl acrylate, vinyl esters of neodecanoic, neononanoic, neopentanoic, 2-ethylhexanoic, or propionic acids (e.g., those available under the trade name VYNATES, available from Union Carbide Corp., located in Danbury, Conn.), vinylidene chloride, styrene, vinyl toluene, and alkyl vinyl ethers.

A second group of monoethylenically unsaturated co-monomers that may be polymerized with the acrylate or methacrylate monomers includes those having a homopolymer glass transition temperature (Tg) less than the glass transition temperature of the acrylate homopolymer. Examples of suitable co-monomers falling within this class include ethyloxyethoxy ethyl acrylate (Tg=−71 degrees Celsius) and a methoxypolyethylene glycol 400 acrylate (Tg=−65 degrees Celsius; available under the trade name NK Ester AM-90G from Shin Nakamura Chemical Co., Ltd.).

A second class of polymers useful in the adhesive includes semicrystalline polymer resins, such as polyolefins and polyolefin copolymers (e.g., polymer resins based upon monomers having between about 2 and about 8 carbon atoms, such as low-density polyethylene, high-density polyethylene, polypropylene, ethylene-propylene copolymers, etc.), polyesters and co-polyesters, polyamides and co-polyamides, fluorinated homopolymers and copolymers, polyalkylene oxides (e.g., polyethylene oxide and polypropylene oxide), polyvinyl alcohol, ionomers (e.g., ethylene-methacrylic acid copolymers neutralized with a base), and cellulose acetate. Other examples of polymers in this class include substantially amorphous polymers such as polyacrylonitrile, polyvinyl chloride, thermoplastic polyurethanes, polycarbonates, amorphous polyesters, amorphous polyamides, ABS block copolymers, polyphenylene oxide alloys, ionomers (e.g., ethylene-methacrylic acid copolymers neutralized with salt), fluorinated elastomers, and polydimethyl siloxane.

A third class of polymers useful in the adhesive includes elastomers containing ultraviolet radiation-activatable groups. Examples include polybutadiene, polyisoprene, polychloroprene, random and block copolymers of styrene and dienes (e.g., SBR), and ethylene-propylene-diene monomer rubber. This class of polymer is typically combined with tackifying resins.

A fourth class of polymers useful in the adhesive includes pressure sensitive and hot melt applied adhesives prepared from non-photopolymerizable monomers. Such polymers can be adhesive polymers (i.e., polymers that are inherently adhesive), or polymers that are not inherently adhesive but are capable of forming adhesive compositions when compounded with components such as plasticizers, or tackifiers. Specific examples include poly-alpha-olefins (e.g., polyoctene, polyhexene, and atactic polypropylene), block copolymer-based adhesives, natural and synthetic rubbers, silicone adhesives, ethylene-vinyl acetate, and epoxy-containing structural adhesive blends (e.g., epoxy-acrylate and epoxy-polyester blends).

A fifth class of polymers useful in the adhesive includes general epoxies including, for example, aromatic epoxies and/or aliphatic epoxies.

In some embodiments, silicone based adhesives may be useful.

The adhesive layer may be radiation cured (e.g., thermally cured, ultraviolet light cured, or electron beam cured) and can be solvent-based, water-based or 100 percent solids.

In some embodiments, the adhesive layer has a thickness of at least 1 micrometer (e.g., at least 5 micrometers). In some embodiments, the adhesive layer is less than 150 micrometers (e.g., less than 50 micrometers, e.g., less than 25 micrometers). In some embodiments, the adhesive layer is from 1 to 150 micrometers, or from 1 to 50 micrometers, or from 1 to 25 micrometers, or from 5 to 150 micrometers, or from 5 to 50 micrometers, or from 5 to 25.

In many instances, the PBS used in various optical imager systems are exposed to significant incident light energy or flux. A consequence of this significant light flux is the inevitable degradation of the organic components of the PBS, diminishing the effective lifetime of the PBS. This disclosure is based around a PBS that includes an adhesive layer having a light stabilizer that improves the stability and/or lifetime of the PBS.

It has been found that including light stabilizers in the adhesive layer(s) 112 and/or 120 improves the stability of the adjacent polyester polarizing film 150. In illustrative embodiments, the light stabilizers include ultraviolet (UV) light absorbers and/or hindered amines. It is surprising that the addition of a UV absorber would improve the operating life of an adjacent polyester polarizing film 150 since measurable UV light is not incident on either the adhesive layer(s) 112 and/or 120 or the polyester polarizing film 150, as described below. In some embodiments, UV light is not emitted by a light source 14, described above. In some embodiments, a UV filter 22 (see FIG. 1) is disposed between the PBS assembly 110 and the light source 14.

UV light absorbers typically function by competitively absorbing UV energy that causes photodegradation of the structure. However, the PBS assemblies 110 described herein, UV light is not directed onto the PBS assembly 110. A wide variety of ultraviolet light-absorbing compounds are commercially available including, for example, benzophenones (e.g., materials sold under the trade names CYASORB UV-531 (available from Cytec Industries Inc., located in West Paterson, N.J.), UVINUL 3008 (available from BASF, located in Mount Olive, N.J.), and LOWILITE22 (available from Great Lake Chemical Corp., West Lafayette, Ind.) triazines (e.g., materials sold under the trade names CYASORB UV-1164 (available from Cytec Industries Inc.), and TINUVIN 405 and TINUVIN 1577 (available from Ciba Specialty Chemicals North America)).

In some embodiments, the ultraviolet light-absorbing compound is present in the adhesive layer(s) 112, 120 in an amount between about 0.25% (e.g., 0.5%, e.g., 1%) and about 5% (e.g. 4%, e.g., 3%) by weight of the adhesive layer(s) 112, 120. In some embodiments, about 0.5% by weight of the ultraviolet light-absorbing compound is present. In some embodiments, about 1% by weight of the ultraviolet light-absorbing compound is present. In some embodiments, about 2% by weight of the ultraviolet light-absorbing compound is present.

Alternatively or in addition to the UVA, the adhesive layer(s) 112, 120 may include a hindered amine light stabilizing (HALS) composition. Generally, the most useful HALS compositions are those derived from a tetramethyl piperidine, and those that can be considered polymeric tertiary amines. Broadly, these include monomeric, oligomeric, and polymeric compounds that contain a polyalkylpiperidine constituent, including polyesters, polyethers, polyamides, polyamines, polyurethanes, polyureas, polyaminotriazines and copolymers thereof. In some embodiments, HALS compositions are those containing compounds made of substituted hydroxypiperidines, including the polycondensation product of a hydroxypiperidines with a suitable acid or with a triazine. Useful HALS compositions are available commercially, for example, under the TINUVIN trade name from Ciba Specialty Chemicals North America such as, for example, TINUVIN 770 and TINUVIN 123. Another useful HALS composition is available commercially, for example, under the LOWILITE92 trade name from Great Lake Chemical Corp.

In some embodiments, the HALS compound is present in the adhesive layer(s) 112, 120 in an amount between about 0.25% (e.g., 0.5%, e.g., 1%) and about 5% (e.g. 4%, e.g., 3%) by weight of the adhesive layer(s) 112, 120. In some embodiments, about 0.5% by weight of the HALS compound is present. In some embodiments, about 1% by weight of the HALS compound is present. In some embodiments, about 2% by weight of the HALS compound is present. In one embodiment, about 0.5% by weight of the HALS compound is present and about 0.5% by weight of the UV absorbing compound is present. In another embodiment, about 1% by weight of the HALS compound is present and about 1% by weight of the UV absorbing compound is present.

Suitable polyester multilayer reflective polarizing films include, for example, those described in U.S. Pat. No. 5,882,774, which is incorporated by reference herein. One embodiment of a suitable polyester multilayer reflective polarizing film includes alternating layers of two materials, at least one of which is birefringent and oriented. In many embodiments, the multilayer film is formed from alternating layers of isotropic and birefringent material. If the plane of the film is considered to be the x-y plane, and the thickness of the film is measured in the z-direction, then the z-refractive index is the refractive index in the birefringent material for light having an electric vector parallel to the z-direction. Likewise, the x-refractive index is the refractive index in the birefringent material for light having its electric vector parallel to the x-direction, and the y-refractive index is the refractive index in the birefringent material for light having its electric vector parallel to the y-direction. For the multilayer reflective polarizing film, the y-refractive index of the birefringent material can be substantially the same as the refractive index of the isotropic material, whereas the x-refractive index of the birefringent material can be different from that of the isotropic material. If the layer thicknesses are chosen appropriately, the film reflects visible light polarized in the x-direction and transmits light polarized in the y-direction. For a polarizer to have high transmission along its pass axis for all angles of incidence, both the y and z (normal to the film) indices of the alternating layers may be matched. Achieving a match for both the y and z indices may utilize a different material set for the layers of the film than that used when only the y index is matched. 3M multi-layer films, such as 3M brand “DBEF” film, were made in the past with a match of the y indices.

One example of a useful polyester multilayer reflective polarizing film is a matched z-index polarizer film, in which the z-refractive index of the birefringent material is substantially the same as the y-refractive index of the birefringent material. Polyester polarizing films having a matched z-index have been described in U.S. Pat. Nos. 5,882,774 and 5,962,114, and in the following U.S. Patent Publications: 2002-0190406; 2002-0180107; 2004-0099992; and 2004-0099993, all of which are incorporated by reference herein. Polyester polarizing films having a matched z-index are also described in U.S. Pat. No. 6,609,795, which is incorporated by reference herein.

The z index mismatch is irrelevant for the transmission of nominally s-polarized light. By definition, nominally s-polarized light does not sense the z-index of refraction of a film. However, as described in co-assigned U.S. Pat. No. 6,486,997, the reflective properties of birefringent multilayer polarizers at various azimuthal angles are such that projection system performance is superior when the PBS is configured to reflect x-polarized (approximately s-polarized) light and transmit y-polarized (approximately p-polarized) light. The optical power or integrated reflectance of a polyester multilayer optical film is derived from the index mismatch within an optical unit or layer pair, although more than two layers may be used to form the optical unit. The use of polyester multilayer reflective films including alternating layers of two or more polymers to reflect light is known and is described, for example, in U.S. Pat. No. 3,711,176; U.S. Pat. No. 5,103,337; WO 96/19347; and WO 95/17303. The placement of this optical power in the optical spectrum is a function of the layer thicknesses. The reflection and transmission spectra of a particular multilayer film depends primarily on the optical thickness of the individual layers, which is defined as the product of the actual thickness of a layer and its refractive index. Accordingly, films can be designed to reflect infrared, visible, or ultraviolet wavelengths λ_{M} of light by choice of the appropriate optical thickness of the layers in accordance with the following formula:
λ_{M}=(2/M)*Dᵣ
wherein M is an integer representing the particular order of the reflected light and Dᵣ is the optical thickness of an optical repeating unit, which is typically a layer pair including one layer of an isotropic material and one layer of an anisotropic material. Accordingly, Dᵣ is the sum of the optical thicknesses of the individual polymer layers that make up the optical repeating unit. Dᵣ, therefore, is one half lambda in thickness, where lambda is the wavelength of the first order reflection peak. In general, the reflectance peak has finite band width, which increases with increasing index difference. By varying the optical thickness of the optical repeating units along the thickness of the multilayer film, a multilayer film can be designed that reflects light over a broad band of wavelengths. This band is commonly referred to as the reflection band or stop band. The collection of layers resulting in this band is commonly referred to as a multilayer stack. Thus, the optical thickness distribution of the optical repeat units within the multilayer film is manifested in the reflection and transmission spectra of the film. When the index matching is very high in the pass direction, the pass state transmission spectrum can be nearly flat and over 95% in the desired spectral range.

The polyester multilayer reflective polarizing films useful in the present disclosure may include thickness distributions that include one or more band packets. A band packet is a multilayer stack having a range of layer thickness such that a wide band of wavelengths is reflected by the multilayer stack. For example, a blue band packet may have an optical thickness distribution such that it reflects blue light, i.e., approximately 400 nm to 500 nm. Multilayer polyester reflective polarizing films of the present disclosure may include one or more band packets each reflecting a different wavelength band, e.g., a multilayer reflective polarizer having a red, a green, and a blue packet. Multilayer polyester reflective polarizing films useful in the present may also include UV and/or IR band packets as well. In general, blue packets include optical repeat unit thicknesses such that the packet tends to reflect blue light and, therefore, will have optical repeat unit thicknesses that are less than the optical repeat unit thicknesses of the green or red packets. The band packets can be separated within a multilayer polyester reflective polarizing film by one or more internal boundary layers.

One embodiment of the present disclosure may include a PBS having substantially right angle triangular prisms used to form a cube. In this case, the polyester polarizing film(s) are sandwiched between the hypotenuses of the two prisms, as described herein. A cube-shaped PBS may be preferred in many projection systems because it provides for a compact design, e.g., the light source and other components, such as filters, can be positioned so as to provide a small, light-weight, portable projector.

Although a cube is one embodiment, other PBS shapes can be used. For example, a combination of several prisms can be assembled to provide a rectangular PBS. For some systems, the cube-shaped PBS may be modified such that one or more faces are not square. If non-square faces are used, a matching, parallel face can be provided by the next adjacent component, such as the color prism or the projection lens.

The prism dimensions, and the resulting PBS dimensions, depend upon the intended application. In an illustrative three panel liquid crystal on silicon (LCoS) light engine described herein in reference to FIG. 3, the PBS can be 17 mm in length and width, with a 24 mm height when using a small arc high pressure Hg type lamp, such as the UHP type sold commercially by Philips Corp. (Aachen, Germany), with its beam prepared as an f/2.3 cone of light and presented to the PBS cubes for use with 0.7 inch diagonal imagers with 16:9 aspect ratio, such as the imagers available from JVC (Wayne, N.J., USA), Hitachi (Fremont, Calif., USA), or Three-Five Systems (Tempe, Ariz., USA). The f# of the beam and imager size are some of the factors that determine the PBS size.

A polyester reflective polarizing PBS assembly can be formed by the following method. An adhesive layer can be disposed (coated or laminated, for example) between a polyester reflective polarizing film and a rigid cover. The adhesive layer can be disposed (coated or laminated, for example) on either the polyester reflective polarizing film or the rigid cover. The adhesive layer can be flexible enough such that the adhesive layer can be deflected while being applied to the polyester reflective polarizing film and/or the rigid cover. Laminating or coating the adhesive layer on the polyester reflective polarizing film and/or the rigid cover can, in some embodiments, prevent noticeable air voids from forming between the adhesive layer and the polyester reflective polarizing film and/or rigid cover. A second rigid cover can be disposed adjacent the polyester reflective polarizing film such that the polyester reflective polarizing film is disposed between the two rigid covers. A second adhesive layer can be disposed between the polyester reflective polarizing film and the second rigid cover. In many embodiments, two or more polyester reflective polarizing films can be included within the PBS assembly, as desired.

A single imager may be used for forming a monochromatic image or a color image. Multiple imagers are typically used for forming a color image, where the illuminating light is split into multiple beams of different color. An image is imposed on each of the beams individually, and these beams are then recombined to form a full color image.

An embodiment of a multi-imager projection system 200 is schematically illustrated in FIG. 3. Light 202 is emitted from a source 304. The source 204 may be an arc or filament lamp, or any other suitable light source for generating light suitable for projecting images, as described above. The source 204 may be surrounded by a reflector 206, such as an elliptic reflector (as shown), a parabolic reflector, or the like, to increase the amount of light directed towards the projection engine.

The light 202 is typically treated before being split into different color bands. The light 202 can be treated by conditioning optics as described above. In some embodiments, the light passes through a UV filter 208, as described above. In some embodiments, the light 202 may also be passed through an optional pre-polarizer, so that only light of a desired polarization is directed towards the projection engine. The pre-polarizer may be in the form of a reflective polarizer, so that reflected light, in the unwanted polarization state, is redirected to the light source 204 for re-cycling. The light 202 may also be homogenized so that the imagers in the projection engine are uniformly illuminated. One approach to homogenizing the light 202 is to pass the light 302 through a reflecting tunnel 210, although it will be appreciated that other approaches to homogenizing the light may also be employed.

In the illustrated embodiment, the homogenized light 212 passes through a first lens 214 to reduce the divergence angle. The light 212 is then incident on a first color separator 216, which may be, for example, a dielectric thin film filter. The first color separator 216 separates light 218 in a first color band from the remaining light 220.

The light 218 in the first color band may be passed through a second lens 222, and optionally a third lens 223, to control the size of the light beam 218 in the first color band incident on the first PBS 224. The light 218 passes from the first PBS 224 to a first imager 226. The imager reflects image light 228 in a polarization state that is transmitted through the PBS 224 to an x-cube color combiner 230. The imager 226 may include one or more compensation elements, such as a retarder element, to provide additional polarization rotation and thus increase contrast in the image light.

The remaining light 220 may be passed through a third lens 232. The remaining light 220 is then incident on a second color separator 234, for example a thin film filter or the like, to produce a light beam 236 in a second color band and a light beam 238 in a third color band. The light 236 in the second color band is directed to a second imager 240 via a second PBS 242. The second imager 240 directs image light 244 in the second color band to the x-cube color combiner 230.

The light 238 in the third color band is directed to a third imager 246 via a third PBS 248. The third imager 246 directs image light 250 in the third color band to the x-cube color combiner 230.

The image light 228, 244 and 250 in the first, second and third color bands is combined in the x-cube color combiner 230 and directed as a full color image beam to projection optics 252. Polarization rotating optics 254, for example half-wave retardation plates or the like, may be provided between the PBSs 224, 242 and 248 and the x-cube color combiner 230 to control the polarization of the light combined in the x-cube color combiner 230. In the illustrated embodiment, polarization rotating optics 254 are disposed between the x-cube color combiner 230 and the first PBS 224 and third PBS 248. Any one, two, or all three of PBSs 224, 242, and 248 may include one or more multilayer reflective polarizing films as described herein.

It will be appreciated that variations of the illustrated embodiment may be used. For example, rather than reflect light to the imagers and then transmit the image light, the PBSs may transmit light to the imagers and then reflect the image light. The above described projection systems are only examples; a variety of systems can be designed that utilize the multifilm PBSs of the present disclosure.

### EXAMPLES

The polyester multilayer reflective polarizing films of the following examples are similar in construction and processing. The films were extruded and drawn in accordance with the general methods described in U.S. Pat. No. 6,609,795 and in accordance with the general methods described in U.S. Patent Publication 2004-0227994.

Experimental Setup

PBS assemblies were built and then tested with a light-irradiating device that focused substantial light onto the MOF film (inside the PBS). The light flux is stated as a multiple of the watts/cm² delivered by a “typical” rear projection television light engine (control). In the accelerated testing the light was 13 times the flux delivered from a typical rear projection light engine, and this is called a “13×” test. The outer temperature of the PBS cube was artificially controlled to about 41 degrees Celsius. Typical tests were completed regularly throughout the experiment's lifetime such as UVN is measurments, color monitoring, contrast measurements, and observations with the naked eye. Failure was determined by an unacceptable functional change in color or contrast.

The experimental samples scanned a range of light stabilizer families that included four structurally different classes of stabilizers. The light stabilizers were mixed into an epoxy-based adhesive used in PBS constructions. The PBS's were built with MOF film designed to reflect a certain polarization of “blue light.” The irradiating light was filtered to deliver light in the blue range, with a 434 nm low wavelength cutoff filter. The stabilizers were from the families of triazoles, triazines, benzophenones, and hinder amines (HALS). There were ten total samples, each being different in terms of the stabilizer package added to the adhesive. The total additive loading equaled 1% by weight of the adhesive. The adhesive was a mixture at a weight ratio of 2.57 units Applitec 5051 part B (Appli-tec, Haverhill, Mass.) to 7.44 units Eponex 1510 (Resolution Performance Products, Houston, Tex.).

Results

The data in the list below describes the number of irradiation hours completed before failure, along with the estimated ratio of the samples' life relative to the non-stabilized sample average.

The sample representing the benzophenone family reached 1360 hours when tested on a nominal 13× tester. This equates to about a 50% increase in lifetime as compared to the average non-stabilized samples. Some triazines also looked promising, with both samples better than the control. One of those triazine samples showed a 60% increase in lifetime relative to control. One sample was a mix of 0.5% triazine (Tinuvin 405) and 0.5% HALS123 (Tinuvin 123), which gave an 80% increase in lifetime relative to control. The HALS lowilite 92 sample was interesting in that it is not a UV absorber and yet showed a 40% lifetime increase. The triazoles were not remarkable in this test. These results did not seem to correlate well with the absorption profiles of the stabilizers. The experiment showed that certain classes of stabilizers are better than others for this particular construction.

| | | Estimated increase in |
|---|---|---|
| | 13x irradiation | lifetime as ratio of non- |
| Stabilizer type | lifetime (hours) | stabilized sample average |
| Non-stabilized samples | 800-950 | 1 |
| (>20 samples tested) | | |
| 1% HALS Lowilite 92 | 1250 | 1.4 |
| 1% HALS Tinuvin 770 | 980 | 1.1 |
| 1% HALS Tinuvin 123 | 1040 | 1.2 |
| 1% triazole Lowilite 27 | 680 | 0.75 |
| 1% triazole CGL139 | 620 | 0.70 |
| 1% benzophenone Lowilite 22 | 1360 | 1.5 |
| 1% triazine Tinuvin 405 | 1450 | 1.6 |
| 1% triazine Tinuvin 1577 | 1090 | 1.2 |
| Mix of 0.5% Tinuvin 405/ | 1600 | 1.8 |
| 0.5% HALS123 | | |
| Mix of 0.5% Tinuvin 1577/ | 1070 | 1.2 |
| 0.5% HALS123 | | |

All references and publications cited herein are expressly incorporated herein by reference in their entirety into this disclosure. Illustrative embodiments of this disclosure are discussed and reference has been made to possible variations within the scope of this disclosure. These and other variations and modifications in the disclosure will be apparent to those skilled in the art without departing from the scope of this disclosure, and it should be understood that this disclosure is not limited to the illustrative embodiments set forth herein. Accordingly, the disclosure is to be limited only by the claims provided below.

What is claimed is:

1. A polarizing beam splitter, comprising:
a polyester polarizing film;
an adhesive layer disposed on the polyester polarizing film, the adhesive layer comprising an adhesive and a light stabilizer selected from the group consisting of hindered amines, benzophenones and triazines;
a first rigid cover disposed on the adhesive layer; and
a second rigid cover disposed adjacent to the polyester polarizing film.

2. A polarizing beam splitter according to claim 1, wherein the first cover is a prism and the second cover is a prism.

3. A polarizing beam splitter according to claim 1, wherein the first cover is a glass prism and the second cover is a glass prism.

4. A polarizing beam splitter according to claim 1, wherein the polyester polarizing film is a multilayer polyester polarizing film.

5. A polarizing beam splitter according to claim 1, wherein the polyester polarizing film is a multilayer reflective polarizing film.

6. A polarizing beam splitter according to claim 1, wherein the polyester polarizing film is a matched z-index multilayer reflective polarizing film.

7. A polarizing beam splitter according to claim 1, wherein the adhesive layer comprises a hindered amine and a triazine.

8. A polarizing beam splitter according to claim 1, wherein the adhesive layer comprises 2-[4-[(2-hydroxy-3-(2′-ethyl)hexyl)oxy]-2-hydroxyphenyl]-4,6-bis(2,4-dimethylphenyl)-1,3,5-triazine.

9. A polarizing beam splitter according to claim 1, wherein the adhesive layer comprises 2-[4-[(2-hydroxy-3-(2′-ethyl)hexyl)oxy]-2-hydroxyphenyl]-4,6-bis(2,4-dimethylphenyl)-1,3,5-triazine, and decanedioic acid, bis(2,2,6,6-tetramethyl-1-(octyloxy)-4-piperidinyl)ester.

10. A projection system, comprising:
a light source to generate light;
an imaging core to impose an image on generated light from the light source to form image light, wherein the imaging core comprises at least one polarizing beam splitter and at least one imager, wherein the polarizing beam splitter comprises:
a polyester polarizing film;
an adhesive layer disposed on the polyester polarizing film and between the light source and the polyester polarizing film, the adhesive layer comprising an adhesive and a U.V. absorber;
a first rigid cover disposed on the adhesive layer; and
a second rigid cover disposed adjacent to the polyester polarizing film;
a ultraviolet light filter disposed between the light source and the imaging core; and
a projection lens system to project the image light from the imaging core.

11. A projection system according to claim 10, wherein the polyester polarizing film comprises a multilayer reflective polarizing film.

12. A projection system according to claim 10, wherein the polyester polarizing film comprises a matched z-index multilayer reflective polarizing film.

13. A projection system according to claim 10, wherein the U.V. absorber comprises a benzophenone or a triazine.

14. A projection system according to claim 10, wherein the adhesive layer further comprises a hindered amine.

15. A projection system according to claim 10, wherein the adhesive layer comprises a hindered amine and a triazine.

16. A method of stabilizing a polyester film, the method comprising:
disposing an adhesive layer on a polyester film, the adhesive layer comprising an adhesive, and a U.V. absorber;
passing light through the adhesive layer and then through the polyester film, wherein at least 99% of the light has a wavelength above 400 nanometers.

17. A method according to claim 16, wherein the passing light step comprises passing light through the adhesive layer and then through the polyester film, wherein at least 99% of the light has a wavelength above 425 nanometers.

18. A method according to claim 16, further comprising a step of passing light through a U.V. filter prior to the passing light through the adhesive layer step.

19. A method according to claim 16, wherein the disposing step comprises disposing an adhesive layer on a polyester film, the adhesive layer comprising an adhesive, and a U.V. absorber selected from the group consisting of benzophenones and triazines.

20. A method according to claim 16, wherein the disposing step comprises disposing an adhesive layer on a polyester film, the adhesive layer further comprising a hindered amine.

21. A method according to claim 16, wherein the disposing step comprises disposing an adhesive layer on a polyester film, the adhesive layer comprising an adhesive, a triazine, and a hindered amine.
